(19) United States
(12) Patent Application Publication
(10) Pub. No.: US 2005/0213541 A1
(43) Pub. Date: Sep. 29, 2005

(54) Method for transmitting service information between network nodes for MBMS service in mobile communication system

(75) Inventors: Myung-Cheul Jung, Seoul (KR); Yong-Woo Shin, Gyeonggi-Do (KR); Min-Jung Kim, Gyeonggi-Do (KR)

Correspondence Address: LEE, HONG, DEGERMAN, KANG &;SCHMADEKA, P.C., 14TH FLOOR, 801 SOUTH FIQUEROA STREET, LOS ANGELES, CA, 90017, US

(73) Assignee: LG Electronics Inc.

(21) Appl. No.: 11/058,022

(22) Filed: Feb. 14, 2005

Related U.S. Application Data
(60) Provisional application No. 60/544,801, filed on Feb. 13, 2004.

(30) Foreign Application Priority Data
Feb. 26, 2004 (KR) 10-2004-013183

(51) Int. Cl. G06F 15/16

(52) U.S. Cl. 370/331; 709/231; 370/437

(57) ABSTRACT

In a method for transmitting service information between network nodes in a wireless system providing one or more multimedia broadcast/multicast service (MBMS), when one terminal is moved from a first network node to a cell managed by a second network node, the first network node receives status information of the cell from the second network node, and when the specific terminal is moved into the cell, the first network node selectively transmits an MBMS connection request message to the second network node. In this case, the status information includes MBMS service area information of a neighboring cell with respect to the MBMS service for which the specific terminal has joined and/or information an MBMS function is supported.

### BACKGROUND OF THE INVENTION

1. Field of the Invention

The present invention relates to a multimedia broadcast/multicast service (MBMS) in a mobile communication system and, more particularly, to a method for transmitting service information between network nodes (elements) when a terminal is moved from one RNC to another RNC.

2. Description of the Related Art

A universal mobile telecommunication system (UMTS), which is a European-type IMT-2000 system, is a third generation mobile communication system that has evolved from a European standard known as Global System for Mobile communications (GSM) that aims to provide an improved mobile communication service based upon a GSM core network and wideband code division multiple access (W-CDMA) wireless connection technology.

FIG. 1 illustrates an exemplary basic structure of a general UMTS network. As shown in FIG. 1, the UMTS is roughly divided into a terminal (or user equipment: UE), a UTRAN, and a core network (CN).

The UTRAN includes one or more radio network sub-systems (RNSs), and each RNS includes one radio network controller (RNC) and a plurality of base stations (referred to as hereinafter ‘Node B’). Each Node B is managed by the RNC, receive information sent by the physical layer of a terminal 10 through an uplink (UL: from terminal to network), and transmit data to a terminal 10 through a downlink (DL: from network to terminal), and operates as an access point (AP) of the UTRAN for the terminal.

The RNC handles allocation of radio resources and serves as AP with the CN.

FIG. 2 illustrates a connection structure between the UTRAN and the terminal in the UMTS network.

With reference to FIG. 2, in order to receive a service provided in the UMTS, the terminal must be connected with the CN, and information of the terminal and the CN is transmitted by way of the UTRAN. The CN and the RNC are connected through an lu interface to transmit and receive data and a control message. Each terminal connected with the UMTS network is managed by a specific RNC of the UTRAN. The RNC managing the terminal is called an SRNC (Serving RNC). Namely, the SRNC refers to the RNC which serves as an AP with the CN for data transmission of a specific terminal.

The SRNC plays a role of a second layer of an OSI (Open System Interface) with respect to data received through a radio interface or transmitted to the terminal and allocates a radio resource suitable for providing a service. Radio resource management functions of the SRNC includes every control functions related to a specific terminal such as setting a transport channel, determining handover or open loop power controlling. A terminal connected with the CN through the UTRAN at a specific point has only one SRNC.

In general, one RNC is used for connection between the terminal and the SRNC, but in case that the terminal is moved into an area handled by a different RNC, the terminal is connected with an SRNC by way of an RNC of the area into which the terminal has moved.

For example, the terminal is initially connected through an R1 (RNC1), and when the terminal is moved into a cell managed by an R2 (RNC2), the terminal is connected to the R1 through an lur interface by wav of R2. That is, The R1 still manages the terminal and serves as an access point with the CN and the R2 simply performs a partial function of routing user data or allocating a code of a common resource.

In the UMTS network, every RNC, except for the SRNC, connected with the terminal is called a DRNC (Drift RNC). One terminal can have the DRNC or one or several DRNCs according to a connection state.

The SRNC and the DRNC transmit and receive signaling messages such as an uplink signaling transfer message, a radio link establishment message and a radio link additional message, etc., through the lur interface.

The discrimination of the SRNC and the DRNC is logical with respect to a specific terminal. Since the RNC and the Node B have a dependent relationship in the UTRAN, the RNC can be discriminated at the side of the Node B. Namely, In order to discriminate an RNC managing the Node B and other RNC, an RNC handling management of a specific Node B is called a CRNC (Controlling RNC). In detail, an RNC which is connected with the Node B by the lub interface and controls radio resources of the Node B corresponds to a CRNC of the Node B. In terms of the structure of the UTRAN, the CRNC and the Node B have a point-to-multipoint relation. The CRNC performs a function of controlling a load and, congestion of traffic in a cell managed by the CRNC itself, controlling acceptance of a new radio link established in the cell, and allocating a code.

A radio resource control (RRC) layer is defined at a third layer of the radio protocol where the RNC and the terminal are positioned. The RRC takes charge of controlling the transport and physical channels with respect to establishment, reconfiguration and release of radio bearers (RBs). In this case, RB service means a service provided by the second layer of the radio protocol for data transmission between the terminal and the UTRAN. The configuration of RB means that characteristics of protocol layers and channels required for providing specific services are regulated as well as the respective specific parameters and operational methods are set up.

When an RRC layer of a specific terminal and an RRC layer of the RNC are connected to transmit and receive an RRC message each other, the terminal is in an RRC connection mode, and when the RRC layer of the specific terminal and the RRC layer of the RNC are not connected, the terminal is in an RRC idle mode state. When the terminal is connected with the RNC by the RRC, an SRNC (Serving RNC) for directly managing the corresponding terminal is generated in the RNC, and thereafter, the RNC recognizes the corresponding terminal by units of cell and manages it.

Meanwhile, if a terminal is in an RRC idle mode state, its existence cannot be recognized by the RNC, the terminal is managed by the CN (MSC or SGSN) by units of location area or routing area, namely, a larger area unit than the cell. That is, as for the terminal in the RRC idle mode state, only its existence can be recognized by the units of larger area, the terminal should be in the RRC connection mode state by making an RRC connection with the RNC in order to receive a general mobile communication service such as a voice or data.

The MBMS will now be described in detail.

The MBMS refers to a method for providing a streaming or background service to multiple terminals by using a downlink-exclusive MBMS bearer service. In the UTRAN, an MBMS bearer uses a point-to-multipoint RB and a point-to-point RB service. The MBMS can be supported only by a system providing a function for the MBMS among UMTS systems of an R6 version. For example, among UMTS system such as R99, R4 and R5 or R6 UMTS system, if a system does not consider the MBMS function, it cannot provide the MBMS.

The MBMS can be classified into a broadcast mode and a multicast mode. The MBMS broadcast mode is a service for transmitting multimedia data to every user in a broadcast area, and the MBMS multicast mode is a service for transmitting multimedia data to only a specific user group of a multicast area. The broadcast area refers to an area where a broadcast service can be provided and the multicast area refers to an area where the multicast service can be provided. The broadcast area and the multicast area are called a service area.

FIG. 3 illustrates a process that the UMTS network provides a specific MBMS (service 1) to the UE by using a multicast mode.

Referring to FIG. 2, first, the user (UE1) desiring to receive a MBMS service must perform a subscription procedure. Here, subscription refers to the acts of establishing a relationship between the service provider and the user. Also, users wishing to receive an MBMS service must also receive a service announcement provided from the network. Here, service announcement refers to the function of informing the terminal about a list (index) of the services to be provided and related information.

Also, if the user intends to receive the multicast mode MBMS service, the user should join a multicast subscription group. Here, ‘multicast group’ refers to a group of users that receive a specific multicast service, and ‘joining’ means merging with the multicast group that has particular users who wish to receive the specific multicast service. Using this joining procedure, the terminal can inform the UTRAN of its intent to receive the particular multicast data (service). In contrast, for a terminal that has joined a particular multicast group, the procedure for terminating the joining of the multicast group is referred to as ‘leaving’. The subscribing, joining, and leaving procedures is performed for each terminal, and a terminal may perform the subscribing, joining, and leaving procedures before, during, or any time after data transmission.

While a particular MBMS service is in progress, one or more sessions for that service may occur in sequence. When data to be transmitted for a particular MBMS service is generated at the MBMS data source, the core network (CN) informs a session start to the RNC. In contrast, when there is no further data to be transmitted for a particular MBMS service, the CN informs a session stop to the RNC. Between the session start and the session stop, data transmission for the particular MBMS service can be performed. Here, only those terminals that have joined a multicast group for the MBMS service may receive data that is transmitted by the data transmission.

In the above session start procedure, the RNC that received the session start from the core network transmits an MBMS notification to the terminals. Here, MBMS notification refers a function of the RNC for informing the terminal that the transmission of data for a particular MBMS service within a certain cell is impending. The MTMS notification is transmitted one or more times until actual data of a service is transmitted. The RNC can perform a counting function of recognizing the number of terminals that wish to receive a particular MBMS service within a particular cell by using the MBMS notification process.

The counting function is used to determine whether the radio bearer for providing the particular MBMS service should be set as point-to-multipoint or point-to-point, or whether no radio bearer is set.

For selecting the MBMS radio bearer, the RNC compares the counted number of terminals with an internally set threshold value. Namely, after performing the counting function, the RNC may set a point-to-point MBMS radio bearer if the number of terminals existing within the corresponding cell is smaller than a threshold value, and may set a point-to-multipoint MBMS radio bearer if the number of terminals existing within the corresponding cell is greater than or equal to the threshold value. After the MBMS radio bearer is set, the RNC informs the terminal about the corresponding radio bearer.

When a point-to-point radio bearer is set for a particular service, terminals that wish to receive the service are all in the RRC connection mode state. However, when a point-to-multipoint radio bearer is set for a particular service, all the terminals wishing to receive the corresponding service need not be in the RRC connection mode state. Namely, terminals in the idle mode state can also receive the point-to-multipoint radio bearer. However, according to the result of the counting process, if no terminal wants the particular MBMS service, the RNC does not set the radio bearer nor transmit the MBMS data. Setting of a radio bearer by the RNC in spite of the fact that no user wants the service is a waste of radio resource.

In addition, when data of the MBMS service is transmitted during one session of the MBMS service from the core network, the RNC starts transmitting data by using the set radio bearer, and when the session stop is received from the CN, the RNC release the previously set radio bearer.

The MBMS service area refers to an area where a specific MBMS service can be provided to a specific terminal. The MBMS service area can be indicated by one or more cells, and can be included in an area managed by one RNC or in an area managed by several RNCs. A list of neighboring cell information refers to a list including information of cells managed by a DRNC positioned near the RNC.

FIG. 4 illustrates an MBMS UE linking process.

As shown in FIG. 4, in the MBMS UE linking process, the SRNC registers a specific terminal, which has subscribed for the specific MBMS service, for an MBMS service context managed by the SRNC itself. The MBMS service context refers to including of information required for managing the specific MBMS service in the UTRAN. If the specific terminal subscribed for the specific MBMS service is moved into a cell handled by the SRNC, the SRNC receives an MBMS UE linking request message from the CN (step S10). Then, the SRNC registers information on the terminal for the MBMS service context with respect to the MBMS service and transmits an MBMS UE linking response message to the CN (step S11). If there is no MBMS service context with respect to the MBMS service, an MBMS service context is newly generated.

FIG. 5 illustrates an MBMS attach process.

With reference to FIG. 5, the RNC providing the MBMS service recognizes and manages a terminal in the RRC connection mode state among terminals participating in a specific MBMS service in each cell handled by the RNC itself. For this purpose, the RNC makes a list of terminals in the RRC connection mode for each MBMS service of each cell. The RRC connection mode terminal list includes identifiers (URNTI) of terminals participating in the specific MBMS service.

The MBMS connection process refers to a process in which with respect to an MBMS service in process among MBMS service for which the terminal in the RRC connection mode state has joined, if the terminal is moved from a cell handled by the SRNC to a cell handled by the DRNC, the SRNC transmits terminal information through an MBMS connection request message to the DRNC so that the DRNC can add the MBMS connection-requested terminal to the RRC connection mode terminal list managed by the DRNC with respect to the MBMS service.

In the meantime, with respect to an MBMS service which is not in process among the MBMS services for which the terminal has joined, after the terminal is moved from the cell handled by the SRNC to the cell handled by the DRNC, when the SRNC receives the session start from the CN with respect to the MBMS service, the SRNC transmits the terminal information to the DRNC through an MBMS connection request message so that the DRNC can add the MBMS connection-requested terminal to the RRC connection mode terminal list. The MBMS connection request message includes an ID of the cell into which the terminal has moved, an ID of the MBMS service for which the terminal has joined, and a terminal identifier (URNTI).

Upon receiving the MBMS connection request message with respect to the specific terminal from the SRNC (step S20), if the DRNC can allocate a resource for maintaining the RRC connection mode state to the terminal, the DRNC accepts the MBMS connection request of the terminal and adds the terminal identifier to the RRC connection mode terminal list with respect to the terminal-joined MBMS service (namely, the MBMS service of the cell into which the terminal has moved). Thereafter, the DRNC transmits a positive response to the SRNC through an MBMS connection response message (step S21).

Upon receiving the MBMS connection response message, the SRNC maintains the terminal in the RRC connection mode state in the cell into which the terminal has moved, and transmits MBMS service data to the terminal by using a point-to-point radio bearer. Namely, the MBMS service data is transmitted to the DRNC through the SRNC and then from the DRNC to the terminal by using the point-to-point radio bearer.

When the DRNC receives the MBMS connection request message with respect to the specific terminal from the SRNC, it does not always accept it. That is, if the DRNC does not have a resource for making the RRC connection and maintaining the RRC connection mode with respect to the terminal, the DRNC rejects the MBMS connection request of the terminal and transmits a negative response to the SRNC.

However, the related art have the following problems when the SRNC transmits the MBMS connection request message to the DRNC.

That is, when the specific terminal is moved into the cell managed by the DRNC, the SRNC transmits the MBMS connection request message to the DRNC regardless of a state of the cell. In this respect, however, if the cell of the DRNC into which the terminal has moved is not included in the MBMS service area of the terminal-joined MBMS service, the cell of the DRNC cannot be provided with the MBMS service. In this case, it is not necessary for the SRNC to transmit the MBMS connection request message with respect to the MBMS service to the DRNC cell where the MBMS service cannot be provided.

In addition, if the DRNC or the Node B of the cell into which the terminal has moved does not support the MBMS function, the cell cannot provide the terminal-joined MBMS service. Also, in this case, the SRNC does not need to transmit the MBMS connection request message to the DRNC which manages the cell.

Nevertheless, in the related art, although the DRNC of the cell into which the terminal has moved, does not need to receive the MBMS connection message, the SRNC unnecessarily transmits the MBMS connection message to the DRNC without knowledge of the corresponding situation. Such transmission of the unnecessary MBMS connection message leads to increase in a signaling load between the SRNC and the DRNC, resulting in increase congestion in the network and degradation of efficiency of using of network resources.

### SUMMARY OF THE INVENTION

Therefore, one object of the present invention is to provide a method for effectively transmitting service information between network nodes in performing an MBMS service.

Another object of the present invention is to provide a method for transmitting service information capable of reducing congestion in a network by reducing a signaling load between an SRNC (Serving Radio Network Controller) and a DRNC (Drift RNC).

Still another object of the present invention is to provide a method for transmitting service information for an MBMS service capable of increasing efficiency of using of network resources by selectively transmitting an MBMS connection request message by an SRNC to a DRNC when a terminal is moved from on RNC to another RNC.

To achieve at least the above objects in whole or in parts, there is provided a method for transmitting service information between network nodes for an MBMS, wherein when a terminal is moved from a first network node to a cell managed by a second network node, the first network node receives status information of the cell from a third network node, and when the specific terminal is moved into the cell later, the first network node selectively transmits an MBMS connection request message to the second network node based on the stored status information.

Preferably, the first network node transmits the MBMS connection request message to the second node only when the cell is the specific MBMS service area or only when the cell supports the MBMS function.

Preferably, the first to the third network nodes are an SRNC, a DRNC and a core network (CN), respectively.

Preferably, the status information includes MBMS service area information of a neighboring cell and/or information on whether an MBMS function is supported with respect to an MBMS service for which the terminal has joined, and is transmitted through one of an lu interface signaling message, an MBMS terminal linking message and an MBMS session start message. In this case, the lu interface signaling message includes whether a neighboring cell supports the MBMS function, and the MBMS terminal linking message and the MBMS session start message includes MBMS service area information of the neighboring cell and information on whether the MBMS function is supported.

To achieve at least these advantages in whole or in parts, there is further provided a method for transmitting service information between network nodes for an MBMS service, wherein when a terminal is moved from a first network node to a cell managed by a second network node, the first network node requests status information of the cell from the second network node, and when the specific terminal is moved into the cell later, the first network node selectively transmits an MBMS connection request message to the second network node according to the received status information.

Preferably, the first network node transmits the MBMS connection request message to the second network node only when the cell is within a specific MBMS service area or supports the MBMS function.

Preferably, the first and second network nodes are an SRNC and a DRNC, respectively.

Preferably, the status information is transmitted through a response message to one of an MBMS connection request message of the first network node, a radio link setup request message and a radio link addition message. The MBMS connection request message includes MBMS service area information of a neighboring cell, the radio link setup request message and the radio link addition message include MBMS service area information of a neighboring cell and information on whether an MBMS function can be supported.

### BRIEF DESCRIPTION OF THE DRAWINGS

The invention will be described in detail with reference to the following drawings in which like reference numerals refer to like elements wherein:

FIG. 1 illustrates an exemplary basic structure of a general UMTS network;

FIG. 2 illustrates a connection structure between a UTRAN and a terminal in the UMTS network;

FIG. 3 illustrates a process of providing a specific MBMS service (service-1) by using a multicast mode in the UMTS network;

FIG. 4 illustrates an MBMS UE linking process;

FIG. 5 illustrates an MBMS attach process;

FIG. 6 illustrates a process in which an SRNC receives a general lu signaling message from a CN and adds a neighboring cell information list;

FIG. 7 illustrates a process in which the SRNC receives an MBMS UE linking message from the CN and adds a neighboring cell information list;

FIG. 8 illustrates a process in which the SRNC receives an MBMS session start message from the CN and adds a neighboring cell information list;

FIG. 9 illustrates a process in which the SRNC receives an MBMS connection response message from the CN and adds a neighboring cell information list; and

FIG. 10 illustrates a process in which the SRNC receives a radio link setup request message from the CN and adds a neighboring cell information list.

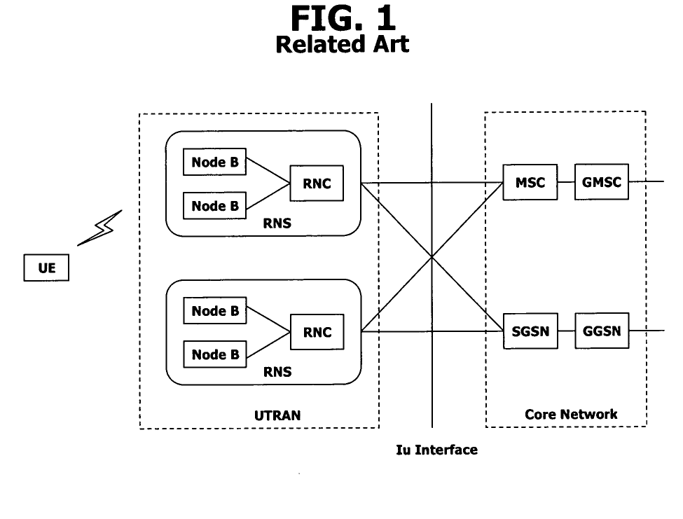

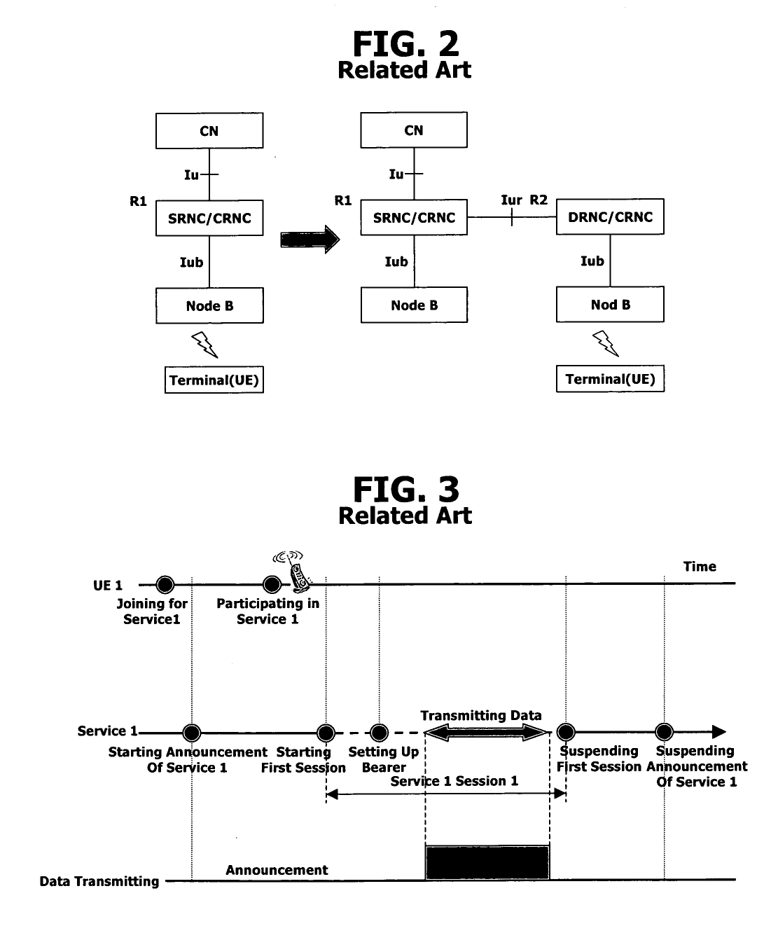

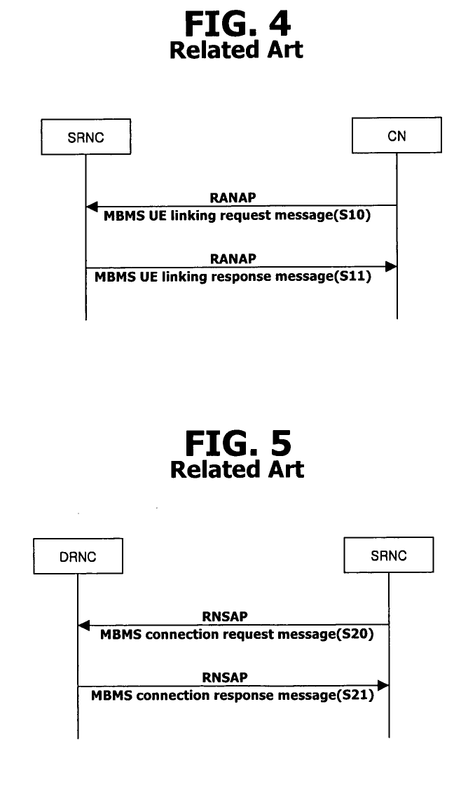

### DETAILED DESCRIPTION OF THE INVENTION

The present invention is implemented in a mobile communication system such as a UMTS (Universal Mobile Telecommunications System) developed by 3GPP. The present invention can be also applied to a communication system operating in a different standard. Preferred embodiments of the present invention will now be described.

The present invention proposes a scheme that an SRNC transmits an MBMS connection request message to a DRNC only when necessary, unlike the related art in which when a specific terminal is moved into a cell managed by the DRNC, the SRNC transmits always the MBMS connection request message to the DRNC regardless of a state of the cell. For this purpose, when the SRNC performs a process for MBMS connection to the DRNC, it receives MBMS service area information of a neighboring cell and information on whether an MBMS function can be provided from an interface (lu or lur), based on which the SRNC determines whether to transmit the MSM connection request message.

In the present invention, information indicating whether a specific cell managed by an RNC provides an MBMS function or not is referred to as MBMS function supportable/non-supportable information. Preferably, the MBMS function supportable/non-supportable information with respect to the cell has MBMS function non-supportable information if a version of an RNC for managing the cell or a version of a Node B providing radio resource to the cell is lower than R6, or if the version of the RNC or the version of the Node B is R6 but has no function of supporting the MBMS service. If the RNC managing the cell or the Node B providing radio resource to the cell have the function of supporting the MBMS service, it has the MBMS function supportable information.

In the present invention, the SRNC receives MBMS service area information of the cell managed by the RNC or an adjacent RNC from the CN connected to the SRNC. In addition, the SRNC receives the terminal-joined MBMS service area information of a cell into which the terminal has moved from a DRNC of the cell into which the specific terminal has moved. Thus, if the SRNC determines that the cell is not the MBMS service area with respect to the MBMS service, when the specific terminal is moved into the cell later, the SRNC does not transmit an MBMS service connection request message with respect to the MBMS service to a DRNC managing the cell, and does not provide the MBMS service or provides a point-to-point service.

In addition, the SRNC receives information on whether the MBMS function can be supported in the cell managed by the RNC or the neighboring RNC from the CN connected to the SRNC itself. In addition, the SRNC receives information on whether the MBMS function can be supported in the cell into which the specific terminal has moved from the DRNC of the cell. If the SRNC determines that the cell does not support the MBMS function, when the specific terminal is moved into the cell, the SRNC does not transmit the MBMS connection request message with respect to every MBMS service to the DRNC managing the cell, does not provide the MBMS service or provides a point-to-point service.

The SRNC can receive MBMS service area information of a neighboring cell or information on whether the MBMS can be supported from the CN connected with the SRNC itself.

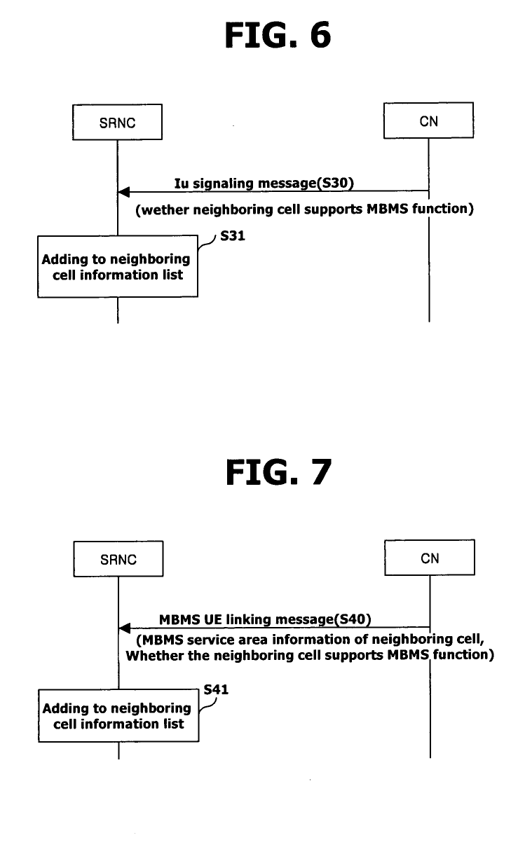

FIG. 6 illustrates a process in which an SRNC receives a general lu signaling message from a CN and adds a neighboring cell information list.

As shown in FIG. 6, the SRNC receives a general lu signaling message from the CN (step S30). The lu signaling message can include information on whether a cell managed by the RNC or a neighboring RNC supports the MBMS function. In addition, the CN can transmit the general lu signaling message to the SRNC regardless of the MBMS service.

The SRNC recognizes the information on whether a cell managed by the RNC or the neighboring RNC supports the MBMS function as included in the lu signaling message, and adds the recognized MBMS function supportable/non-supportable information to a neighboring cell information list (step S31). Accordingly, when a specific terminal is moved into the cell, if the SRNC determines that the cell does not support the MBMS function based on the MBMS function supportable/non-supportable information, the SRNC does not transmit an MBMS connection request message with respect to every MBMS service to a DRNC managing the cell, and does not provide every MBMS service to the terminal or provides a point-to-point service.

FIG. 7 illustrates a process in which the SRNC receives an MBMS UE linking message from the CN and adds a neighboring cell information list.

As shown in FIG. 7, the SRNC receives an MBMS UE linking message from the CN (step S40). At this time, the MBMS UE linking message includes neighboring cell MBMS service area information with respect to MBMS services for which a specific terminal has joined and MBMS service function supportable/non-supportable information of the neighboring cell with respect to every MBMS service.

The SRNC recognizes the MBMS service area information of the neighboring cell and the MBMS function supportable/non-supportable information of the neighboring cell included in the message and adds the recognized service area information to the neighboring cell information list (step S41). Thereafter, when the specific terminal is moved into the cell, if the cell is determined not to be the MBMS service are of the MBMS service, the SRNC does not transmit the MBMS connection request message with respect to the MBMS service to the DRNC managing the cell, does not provide the MBMS service to the terminal or provides a point-to-point service.

In addition, the SRNC can add the MBMS function supportable/non-supportable information of the neighboring cell to the neighboring cell information list. In this case, when the specific terminal is moved into the cell, if the cell is determined not to support the MBMS function, the SRNC does not the MBMS connection request message with respect to every MBMS service to the DRNC managing the cell, and provides every MBMS service to the terminal or provides a point-to-point service.

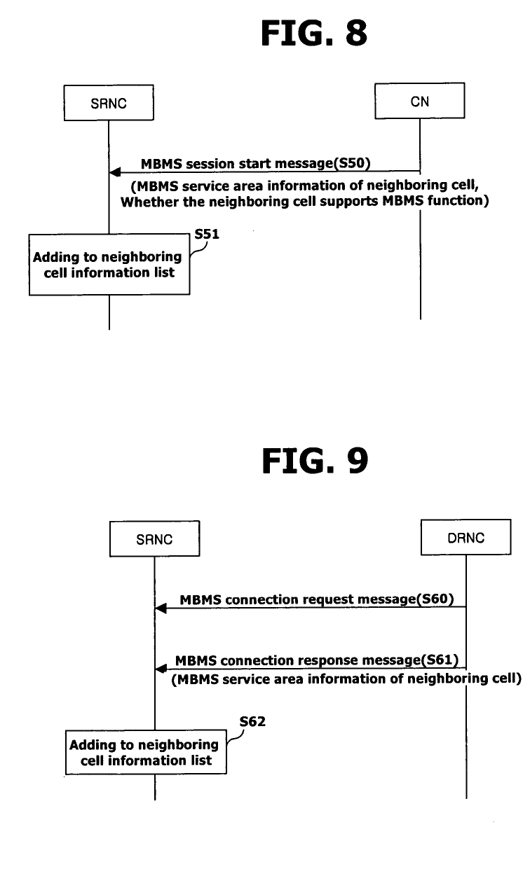

FIG. 8 illustrates a process in which the SRNC receives an MBMS session start message from the CN and adds a neighboring cell information list.

First, the SRNC receives an MBMS session start message from the CN (step S50). The MBMS session start message includes neighboring cell MBMS service area information with respect to MBMS services for which a specific terminal has joined and information on whether a neighboring cell can support MBMS service function with respect to every MBMS service.

The SRNC recognizes the MBMS service area information of the neighboring cell and the information on whether the neighboring cell can support the MBMS function as included in the message and then adds the MBMS service area information to the neighboring cell information list (step S51). Thereafter, when the specific terminal is moved into the cell, if the cell is determined not an MBMS service area of the MBMS service, the SRNC does not transmit an MBMS connection request message with respect to the MBMS service to a DRNC managing the cell, and does not provide the MBMS service to the terminal or provides a point-to-point service.

In addition, the SRNC can add the information on whether the neighboring cell can support the MBMS function to the neighboring cell information list. Accordingly, when a specific terminal is moved into the cell, if the cell is determined not support the MBMS function, the SRNC does not transmit an MBMS connection request message with respect to every MBMS service to the DRNC managing the cell, and does not provide every MBMS service to the terminal or provides a point-to-point service.

FIG. 9 illustrates a process in which the SRNC receives an MBMS connection response message from the CN and adds a neighboring cell information list.

With reference to FIG. 9, when a terminal moves into a cell managed by a DRNC, the SRNC senses the movement of the terminal and transmits an MBMS connection request message with respect to the MBMS service being received by the terminal to a DRNC (step S60). The DRNC transmits an MBMS connection response message to the SRNC in response to the MBMS connection request message (step S61). At this time, the MBMS connection response message includes MBMS service area information of the cell into which the terminal has moved.

The SRNC receives the MBMS connection response message from the DRNC, checks the MBMS service area information of the terminal-moved cell, and adds the checked MBMS service area information into the neighboring cell information list (step S62). Thereafter, when a specific terminal is moved into the cell, if the SRNC determines that the cell is not the MBMS service area of the MBMS service, the SRNC does not transmit the MBMS connection request message with respect to the MBMS service to the DRNC managing the cell, does not provide the MBMS service to the terminal or provides a point-to-point service.

In addition, in the present invention, the SRNC can receive MBMS service area information with respect to every MBMS service of a neighboring cell and information on whether the neighboring cell can support an MBMS function by using an uplink signaling transmission message, a radio link setup message and a radio link addition message.

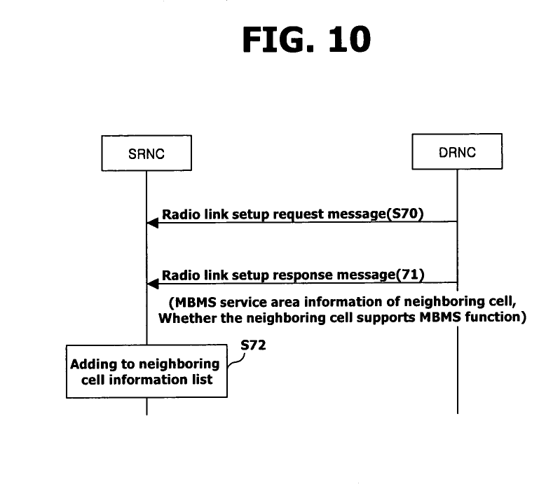

FIG. 10 illustrates a process in which the SRNC receives a radio link setup request message from the CN and adds a neighboring cell information list.

As shown in FIG. 10, when a terminal is moved into a cell managed by the DRNC, the SRNC senses the movement of the terminal and transmits a radio link setup request message to the DRNC for setting up a radio link for the terminal (step S70). The DRNC transmits a radio link setup response message to the radio link setup request message to the SRNC (step S71), and in this case, the radio link setup response message includes MBMS service area information with respect to every MBMS service of the cell into which the terminal has moved and information on whether the MBMS function can be supported.

Accordingly, the SRNC receives the link setup response message from the DRNC and checks the MBMS service area information MBMS service area information of the terminal-moved cell, and adds the corresponding MBMS service area information to the neighboring cell information list (step S72). Thereafter, when the terminal is moved into the cell, if the SRNC determines that the cell is no the MBMS service are of the specific MBMS service, the SRNC does not transmit the MBMS connection request message with respect to the MBMS service to the DRNC managing the cell, and does not provide the MBMS service to the terminal or provides a point-to-point service.

In addition, the SRNC can check the information on whether the cell, into which the terminal has moved, supports the MBMS function, and add it to the neighboring cell information list. In this case, when a specific terminal is moved into the cell, if the SRNC determines that the cell does not support the MBMS function, it does not transmit the MBMS connection request message with respect to every MBMS service to the DRNC managing the cell, and does not provide every MBMS service to the terminal or provides a point-to-point service.

As so far described, in the present invention, when a specific terminal is moved into a cell managed by the DRNC, the SRNC does not transmit the MBMS connection request message to the DRNC regardless of a state of the cell, but transmits the MBMS connection request message only when it is necessary.

That is, the SRNC receives the MBMS service area information of the neighboring cell and information on whether the MBMS function is supported from the CN or from the DRNC, stores them, and then, if the cell into which the specific terminal has moved is not the MBMS service area of the specific MBMS service or does not support the MBMS function, the SRNC does not transmit the MBMS connection request message to the DRNC managing the cell, does not provide the MBMS service, to the terminal or provides the point-to-point service.

Therefore, when the terminal is moved from one RNC to another RNC, unnecessary message transmission between the RNCs can be reduced. Accordingly, an increase in a network load between the RNCs and thus network use efficiency can be enhanced.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A method for transmitting service information between network nodes in a wireless system providing one or more multimedia broadcast/multicast service (MBMS), wherein when a terminal (user equipment (UE)) is moved from a first network node to a cell managed by a second network node, the first network node receives status information of the cell from a third network node.

2. The method of claim 1, wherein the status information indicates MBMS service area information of a neighboring cell with respect to an MBMS service for which the terminal has joined and/or information on whether an MBMS function is supported.

3. The method of claim 1, wherein the status information is transmitted through one of an lu interface signaling message of the third node, an MBMS UE inking message and an MBMS session start message.

4. The method of claim 3, wherein the lu interface signaling message includes information on whether a neighboring cell supports the MBMS function and the MBMS UE linking message and the MBMS session start message includes information MBMS service area information of the neighboring cell and information on whether the MBMS function is supported.

5. The method of claim 1, wherein the first network node stores the status information received from the third network node in a neighboring cell information list, and when the specific terminal is moved into the cell, the first network node transmits an MBMS connection request message to the second network node according to the stored status information.

6. The method of claim 5, wherein the first network node transmits the MBMS connection request message to the second node only when the cell is the specific MBMS service area or only when the cell supports the MBMS function.

7. The method of claim 5, wherein the first network node is an SRNC (Serving Radio Network Controller) managing the specific terminal, the second network node is a DRNC (Drift RNC) of the cell into which the terminal has moved, and the third network node is a core network (CN).

8. A method for transmitting service information between network nodes in a wireless system providing one or more multimedia broadcast/multicast service (MBMS), wherein when one terminal is moved from a first network node to a cell managed by a second network node, the second network node provides status information of the cell according to a request of the first network node.

9. The method of claim 8, wherein the status information is transmitted through a response message with respect one of an MBMS connection request message of the first network node, a radio link setup request message and a radio link addition message.

10. The method of claim 9, wherein the MBMS connection request message includes an MBMS service area information of a neighboring cell and the radio link setup request message and the radio link addition message include MBMS service area information of the neighboring cell and information on whether an MBMS function is supported.

11. The method of claim 8, wherein the first network node is an SRNC (Serving Radio Network Controller) managing the specific terminal and the second network node is a DRNC (Drift RNC) of a cell into which the terminal has moved.

12. The method of claim 8, wherein the first network node stores the status information received from the second network node, so that when the specific terminal is moved into the cell later, the first network node selectively transmits an MBMS connection request message to the second network node based on the stored status information.

13. A method for transmitting service information between network nodes in a wireless system providing one or more multimedia broadcast/multicast service (MBMS), wherein when a terminal is moved from a first network node to a cell managed by a second network node, the first network node receives status information of the cell from a third network node, and when the specific terminal is moved into the cell later, the first network node selectively transmits an MBMS connection request message to the second network node according to the stored status information.

14. The method of claim 13, wherein the first network node stores the status information in a neighboring cell information list, and only when the cell is a specific MBMS service area or only when the cell supports an MBMS function, the first network node transmits an MBMS connection request message to the second network node.

15. The method of claim 13, wherein the first network node is an SRNC (Serving Radio Network Controller) managing the specific terminal, the second network node is a DRNC (Drift RNC) of the cell into which the terminal has moved, and the third network node is a core network (CN).

16. The method of claim 13, wherein the status information indicates MBMS service area information of a neighboring cell with respect to an MBMS service for which the terminal has joined and/or information on whether an MBMS function is supported.

17. The method of claim 13, wherein the status information is transmitted through one of an lu interface signaling message of the third node, an MBMS UE linking message and an MBMS session start message.

18. The method of claim 17, wherein the lu interface signaling message includes information on whether a neighboring cell supports the MBMS function and the MBMS UE linking message and the MBMS session start message includes information MBMS service area information of the neighboring cell and information on whether the MBMS function is supported.

19. A method for transmitting service information between network nodes in a wireless system providing one or more multimedia broadcast/multicast service (MBMS), wherein when a terminal is moved from a first network node to a cell managed by a second network node, the first network node requests status information of the cell from the second network node, and when the specific terminal is moved into the cell later, the first network node selectively transmits an MBMS connection request message to the second network node according to the received status information.

20. The method of claim 19, wherein the first network node stores the status information received in a neighboring cell information list, and transmits the MBMS connection request message to the second node only when the cell is the specific MBMS service area or only when the cell supports the MBMS function.

21. The method of claim 19, wherein the first network node is an SRNC (Serving Radio Network Controller) managing the specific terminal and the second network node is a DRNC (Drift RNC) of a cell into which the terminal has moved.

22. The method of claim 19, wherein the status information is transmitted through a response message with respect one of an MBMS connection request message of the first network node, a radio link setup request message and a radio link addition message.

23. The method of claim 22, wherein the MBMS connection request message includes an MBMS service area information of a neighboring cell and the radio link setup request message and the radio link addition message include MBMS service area information of the neighboring cell and information on whether an MBMS function is supported.
